(19) United States
(12) Patent Application Publication
(10) Pub. No.: US 2011/0221608 A1
(43) Pub. Date: Sep. 15, 2011

(54) ELECTRONIC DEVICE AND METHOD FOR MONITORING USER STATE

(75) Inventors: HOU-HSIEN LEE, Tu-Cheng, Taipei Hsien (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/848,207

(22) Filed: Aug. 1, 2010

(30) Foreign Application Priority Data
Mar. 15, 2010 (CN) 201010124381.6

(51) Int. Cl. G08B 21/00; H04N 5/228

(52) U.S. Cl. 340/686.6; 348/222.1; 348/E05.031

(57) ABSTRACT

A method that monitors user state using an electronic device locates a face shape from a current image of a user captured by an image capturing device of the electronic device, and calculates a current area of the face shape when the user reads digital material using the electronic device. Additionally, the method determines whether the current area is greater than a standard area stored in a storage system of the electronic device, and triggers a warning device of the electronic device to output an alarm signal to warn the user to keep a proper distance from the electronic device upon the condition that the current area is greater than the standard area.

### BACKGROUND

1. Technical Field

Embodiments of the present disclosure relate generally to electronic devices, and more particularly, to a method for monitoring user state using an electronic device.

2. Description of Related Art

Many people read digital material using electronic devices. For example, many people read news, electronic magazines, electronic books, and electronic novels using mobile phones or personal digital assistants (PDAs). However, it may harmful to eyes of a user if a distance between the eyes and the electronic device is too short. Additionally, people often fall asleep while they are reading the digital material when the electronic devices remain in a powered-on state, which may consume a lot of power resulting in battery power loss.

### BRIEF DESCRIPTION OF THE DRAWINGS

FIG. 1 is a block diagram of one embodiment of an electronic device.

FIG. 2 and FIG. 3 are schematic diagrams illustrating examples of a user reading digital material using the electronic device.

FIG. 4 is a flowchart of one embodiment of a method for monitoring user state using the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

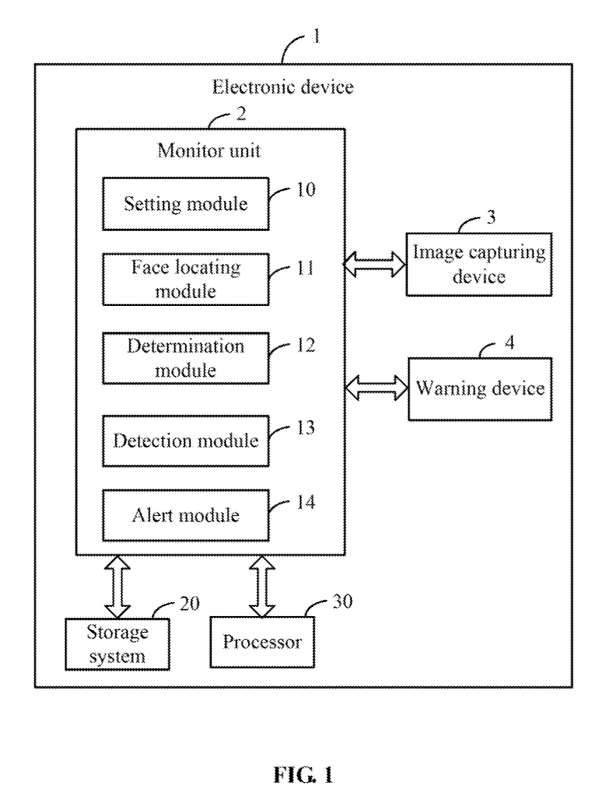

FIG. 1 is a block diagram of one embodiment of an electronic device 1. In the embodiment, the electronic device 1 includes a monitor unit 2, an image capturing device 3, a warning device 4, a storage system 20 and a processor 30. In some embodiments, the electronic device 1 may be a mobile phone, a personal digital assistant (PDA), or any other electronic devices that can be used to read digital material. The digital material may be, for example, news, electronic magazines, electronic books, and electronic novels. It should be apparent that FIG. 1 is only one example of the electronic device 1 architecture that can be included with more or fewer components than shown in other embodiments, or a different configuration of the various components.

The image capturing device 3 is positioned on the electronic device 1. In some embodiments, the image capturing device 3 may be a video camera, or a digital camera, for example. The image capturing device 3 is operable to capture images of a user at regular intervals when the user reads the digital material using the electronic device 1, and sends the captured images to monitor unit 2 to analyze. The regular intervals may be predetermined by the user, such as three seconds or five seconds. Detail of analyzing the images are provided below.

The storage system 20 stores one or more programs, such as programs of an operating system, and other applications of the electronic device 1. In one embodiment, the storage system 20 may be random access memory (RAM) for temporary storage of information, and/or a read only memory (ROM) for permanent storage of information. In other embodiments, the storage system 20 may also be an external storage device, such as a hard disk, a storage card, or a data storage medium. The processor 30 executes one or more computerized operations of the electronic device 1 and other applications, to provide functions of the electronic device 1.

The monitor unit 2 may include a plurality of functional modules comprising one or more computerized instructions that are stored in the storage system 20 or a computer-readable medium of the electronic device 1, and executed by the processor 30 to perform operations of the electronic device 1. In one embodiment, the monitor unit 2 includes a setting module 10, a face locating module 11, a determination module 12, a detection module 13, and an alert module 14. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

The setting module 10 is operable to preset a standard image of the user captured by the image capturing device 3 when the user reads digital material of the electronic device in a proper distance between eyes of the user and the electronic device 1. In one embodiment, the standard image may be captured by the image capturing device 3 when the user reads the digital material at the proper distance. The distance may be a linear distance between eyes of the user and a display screen of the electronic device 1.

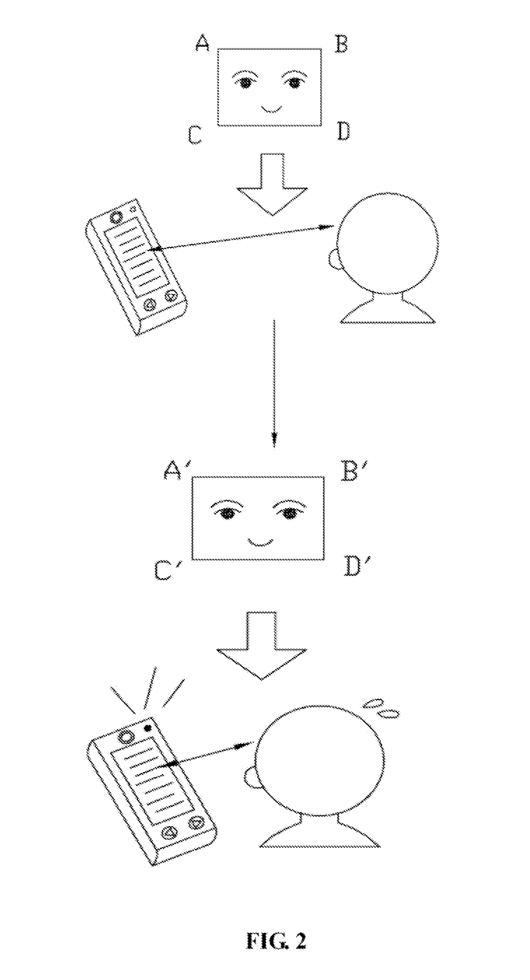

The face locating module 11 is operable to locate a standard face shape (as shown in rectangle ABCD of FIG. 2) from the standard image, calculate a standard area of the standard face shape, and store the standard area in the storage system 20.

In one embodiment, the face locating module 11 locates the face shape using a skin color model in YCbCr space. In YCbCr, the Y is the brightness (luma), Cb is blue minus luma (B-Y), and Cr is red minus luma (R-Y) of an image. One example of an equation for finding facial skin is described as follows.

$$P ( x , y ) = \{ \begin{matrix}1 , & if [ 135 \leq Cr ( x , y ) \leq 156 ] ⋂ [ 108 \leq Cb ( x , y ) \leq 123 ] \\ 0 , & otherwise\end{matrix}$$

In the equation, “P” stands for a pixel in the image, and “(x, y)” stands for a coordinate value of the pixel “P”. In one embodiment, a value of Cr(x, y) ranges from 135 to 156, a value of Cb(x, y) ranges from 108 to 123. In other embodiments, the values of the Cr(x, y) and the Cb(x, y) may be any other suitable ranges. If the coordinate value of the pixel P(x, y) is 1, the face locating module 11 determines that facial characteristics are included in the image. If the coordinate value of the pixel P(x, y) is 0, the face locating module 11 determines that facial characteristics are not included in the image.

The face locating module 11 further controls the image capturing device 3 to capture a current image of the user when the user reads the digital material of the electronic device 1, locate a current face shape (as shown in A′B′C′D′ of FIG. 2) from the current image, and calculate a current area of the current face shape.

The determination module 12 determines whether the current area of the current face shape is greater than the standard area stored in the storage system 20, and triggers the warning device 4 to output an alarm signal to prompt the user to keep a proper distance from the electronic device 1 if the current area is greater than the standard area. It may be harmful to the eyes of the user, if the distance between the eyes of the user and the electronic device 1 is too short, which causes the current area to be greater than the standard area. Therefore, it is necessary to warn the user when the current area is greater than the standard area. In one embodiment, the warning device 4 may be a light emitting diode (LED) or a buzzer, for example. As such, the alarm signal may be a flashing light output by the LED or audio output by the buzzer.

The detection module 13 detects whether the current image of the user has characteristics of an eyeball in the current image of the user (hereinafter, “eyeball characteristics”). The detection module 13 further measures an elapsed time when a plurality of images of the user continuously captured by the image capturing device 3 have no eyeball characteristics, and determines whether the measured time exceeds a predetermined time. The predetermined time may be predetermined by the user, such as 5 minutes or 10 minutes. In one embodiment, the detection module 13 may detect the eyeball characteristics by comparing eyeball templates pre-stored in the storage system 20 with the current image of the user. It should be understood that characteristics of an eyeball may include shape and color of the eyeball, among other features.

The alert module 14 powers off the electronic device 1, and triggers the warning device 3 to output an alarm signal to warn the user when the measured time exceeds the predetermined time. In one embodiment, it may be determined that the user is falling asleep or away from the electronic device 1, if the eyeball characteristics are not detected on the continuously captured images within the predetermined time. Therefore, it is necessary to power off the electronic device 1 to conserve the power of the electronic device 1 and output an alarm signal to warn the user, when the measured time exceeds the predetermined time.

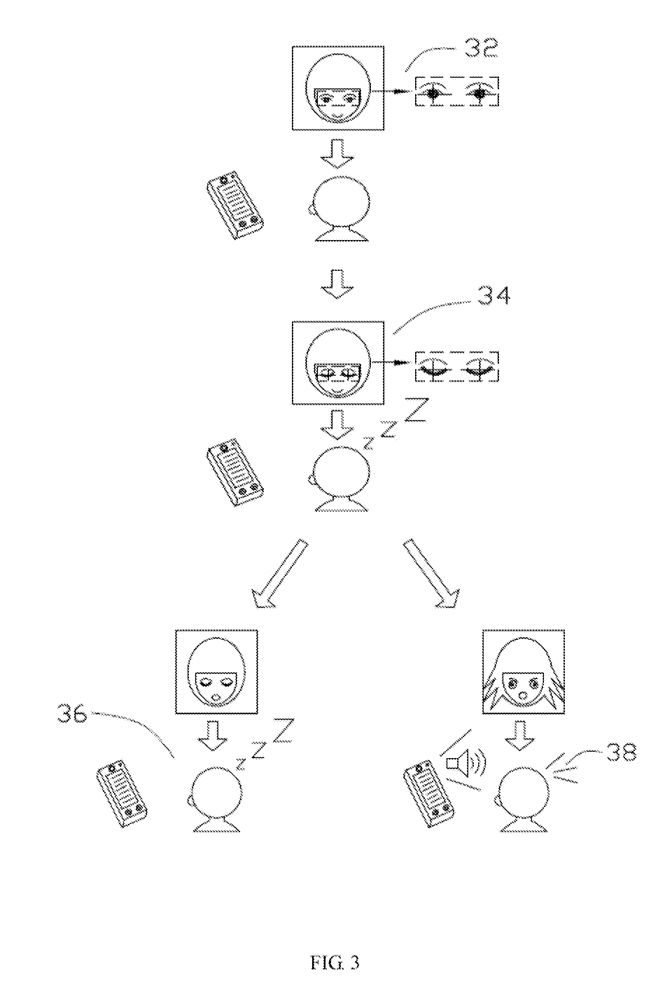

FIG. 2 and FIG. 3 are schematic diagrams illustrating examples of a user reading digital material using the electronic device 1. Referring to FIG. 2, if a current area of the current face shape (e.g., the face shape in rectangle A′B′C′D′) on the captured image of the user is greater than the standard area of the standard face shape (e.g., the face shape in the rectangle ABCD), the warning device 4 is triggered to output an alarm signal to warn the user to keep the proper distance from the electronic device 1. Referring to FIG. 3, the detection module 13 detects eyeball characteristics on the current image 32. It may denote that the user is falling asleep (e.g., 34 in FIG. 3) if the detection module 13 does not detect eyeball characteristics on the images of the user continuously captured by the capturing device 3 within the predetermined time. In response to the sleep state of the user, the alert module 14 powers off the electronic device 1 to conserve the power (e.g., 36 in FIG. 3), and triggers the warning device 3 to output an alarm signal to warn the user (e.g., 38 in FIG. 3).

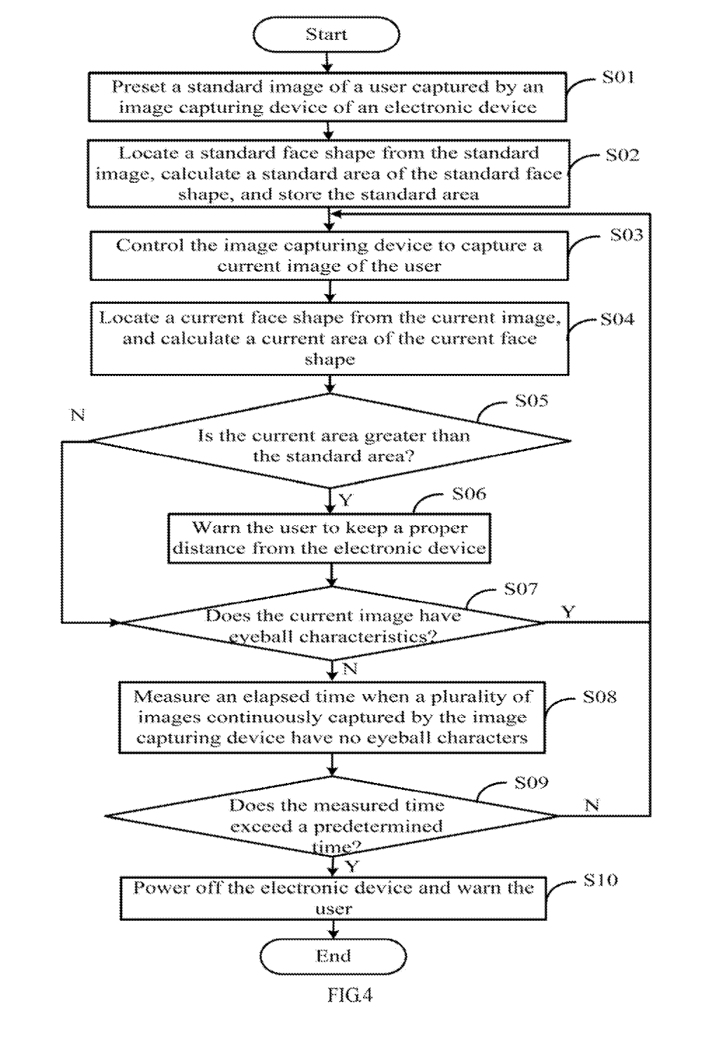

FIG. 4 is a flowchart of one embodiment of a method for monitoring user state using the electronic device 1 of FIG. 1. The method can detect user state when a user reads digital material using the electronic device 1, and control the electronic device 1 to implement corresponding functions in response. Depending on the embodiment, additional blocks may be added, others removed, and the ordering of the blocks, may be changed.

In block S01, the setting module 101 presets a standard image of the user captured by the image capturing device 3. The standard image may be captured by the image capturing device 3 when the user reads the digital material at a proper distance between eyes of the user and the electronic device 1.

In block S02, the face locating module 11 locates a standard face shape (as shown in rectangle ABCD of FIG. 2) from the standard image, calculates a standard area of the standard face shape, and stores the standard area in the storage system 20.

In block S03, the face locating module 11 controls the image capturing device 3 to capture a current image of the user when the user reads digital material of the electronic device 1. And in block S04, the face locating module 11 locates a current face shape (as shown in A′B′C′D′ of FIG. 2) from the current image, and calculates a current area of the current face shape.

In block S05, the determination module 12 determines whether the current area of the current face shape is greater than the standard area. If the current area is greater than the standard area, block S06 is implemented, otherwise, if the current area is not greater than the standard area, block S07 is implemented.

In block S06, the determination module 12 triggers the warning device 4 to output an alarm signal to warn the user to keep a proper distance from the electronic device 1.

In block S07, the detection module 13 detects whether the current image has eyeball characteristics. If the current image has eyeball characteristics, block S03 is repeated, otherwise, if the current image has no eyeball characteristics, block S08 is implemented.

In block S08, the detection module 13 measures an elapsed time when the detection module 13 does not detect eyeball characteristics on a plurality of images of the user continuously captured by the image capturing device 3.

In block S09, the detection module 13 determines whether the measured time exceeds a predetermined time. If the measured time exceeds the predetermined time, block S10 is implemented, otherwise, if the measured does not exceed the predetermined time, block S03 is repeated. The predetermined time may be predetermined by the user, such as 5 minutes or 10 minutes, for example.

In block S10, the alert module 14 powers off the electronic device 1, and triggers the warning device 3 to output an alarm signal to warn the user.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for monitoring user state using an electronic device, the method comprising:
controlling an image capturing device of the electronic device to capture a current image of a user, when the user reads digital material using the electronic device;
locating a current face shape from the current image;
calculating a current area of the current face shape;
determining whether the current area is greater than a standard area stored in a storage system of the electronic device; and
triggering a warning device of the electronic device to output an alarm signal to warn the user to keep a proper distance between eyes of the user and the electronic device upon the condition that the current area is greater than the standard area.

2. The method according to claim 1, further comprising:
presetting a standard image of the user captured by the image capturing device when the user reads digital material of the electronic device at the proper distance from the electronic device;
locating a standard face shape from the standard image;
calculating a standard area of the standard face shape; and
storing the standard area in the storage system.

3. The method according to claim 1, further comprising:
detecting whether the current image has eyeball characteristics; and
measuring an elapsed time when a plurality of images of the user continuously captured by the image capturing device have no eyeball characteristics upon the condition that the current image has no eyeball characteristics; or
returning to the controlling step upon the condition that the current image has eyeball characteristics.

4. The method according to claim 3, further comprising:
determining whether the measured time exceeds a predetermined time; and
powering off the electronic device, and triggering the warning device to out put an alarm signal to warn the user upon the condition that the measured time exceeds the predetermined time; or
returning to the controlling step upon the condition that the measured time does not exceed the predetermined time.

5. The method according to claim 1, wherein the digital material comprise news, electronic magazines, electronic books, and electronic novels.

6. An electronic device, the electronic device comprising:
a storage system;
an image capturing device;
at least one processor; and
a monitor unit stored in the storage system and being executable by the at least one processor, the monitor unit comprising:
a face locating module operable to control the image capturing device to capture a current image of a user, locate a current face shape from the current image, and calculate a current area of the current face shape, when the user reads digital material using the electronic device; and
a determination module operable to determine whether the current area is greater than a standard area stored in the storage system, and trigger the warning device to output an alarm signal to warn the user to keep a proper distance between eyes of the user and the electronic device upon the condition that the current area is greater than the standard area.

7. The electronic device according to claim 6, wherein the monitor unit further comprises:
a setting module operable to preset a standard image of the user captured by the image capturing device when the user reads digital material of the electronic device at the proper distance from the electronic device.

8. The electronic device according to claim 7, wherein the face locating module is further operable to locate a standard face shape from the standard image, calculate a standard area of the standard face shape, and store the standard area in the storage system.

9. The electronic device according to claim 6, wherein the monitor unit further comprises:
a detection module operable to detect whether the current image has eyeball characteristics, measure an elapsed time when a plurality of images of the user continuously captured by the image capturing device have no eyeball characteristics upon the condition that the current image has no eyeball characteristics, and determine whether the measured time exceeds a predetermined time; and
an alert module operable to power off the electronic device and trigger the warning device to output an alarm signal to warn the user upon the condition that the measured time exceeds the predetermined time.

10. The electronic device according to claim 6, wherein the digital material comprise news, electronic magazines, electronic books, and electronic novels.

11. A storage medium storing a set of instructions, the set of instructions capable of being executed by a processor of an electronic device, causing the electronic device to perform a method for monitoring user state, the method comprising:
controlling an image capturing device of the electronic device to capture a current image of a user, when the user reads digital material using the electronic device;
locating a current face shape from the current image;
calculating a current area of the current face shape;
determining whether the current area is greater than a standard area stored in a storage system of the electronic device; and
triggering a warning device of the electronic device to output an alarm signal to warn the user to keep a proper distance between eyes of the user and the electronic device upon the condition that the current area is greater than the standard area.

12. The storage medium as claimed in claim 11, wherein the method further comprises:
presetting a standard image of the user captured by the image capturing device when the user reads digital material of the electronic device at the proper distance from the electronic device;
locating a standard face shape from the standard image;
calculating a standard area of the standard face shape; and
storing the standard area in the storage system.

13. The storage medium as claimed in claim 11, wherein the method further comprises:
detecting whether the current image has eyeball characteristics; and
measuring an elapsed time when a plurality of images of the user continuously captured by the image capturing device have no eyeball characteristics upon the condition that the current image has no eyeball characteristics; or
returning to the controlling step upon the condition that the current image has eyeball characteristics.

14. The storage medium as claimed in claim 13, wherein the method further comprises:
determining whether the measured time exceeds a predetermined time; and
powering off the electronic device, and triggering the warning device to output an alarm signal to warn the user upon the condition that the measured time exceeds the predetermined time; or
returning to the controlling step upon the condition that the measured time does not exceed the predetermined time.

15. The storage medium as claimed in claim 11, wherein the digital material comprise news, electronic magazines, electronic books, and electronic novels.
